(19) United States
(12) Patent Application Publication
(10) Pub. No.: US 2026/0089673 A1
(43) Pub. Date: Mar. 26, 2026

(54) METHODS AND APPARATUSES FOR RAT-DEPENDENT POSITIONING INTEGRITY

(71) Applicant: LENOVO (BEIJING) LIMITED, Beijing (CN)

(72) Inventors: Lihua YANG, Beijing (CN); Jie HU, Beijing (CN); Jing HAN, Beijing (CN); Haiming WANG, Beijing (CN); Luning LIU, Beijing (CN)

(21) Appl. No.: 19/111,169

(22) PCT Filed: Sep. 23, 2022
(86) PCT No.: PCT/CN2022/120946

§ 371 Date: Mar. 12, 2025

(51) Int. Cl. H04W 64/00

(52) U.S. Cl. CPC H04W 64/00

(57) ABSTRACT

Embodiments of the present disclosure relate to methods and apparatuses for radio access technology (RAT) dependent positioning integrity. According to an embodiment of the present disclosure, a user equipment (UE) may include: a processor configured to obtain integrity assistance data of the UE; a transmitter coupled to the processor and configured to transmit the integrity assistance data of the UE to a location management function (LMF); and a receiver coupled to the processor.

### TECHNICAL FIELD

Embodiments of the present application generally relate to wireless communication technologies, and especially to methods and apparatuses for radio access technology (RAT) dependent positioning integrity.

### BACKGROUND

Positioning integrity refers to a measure of trust in an accuracy of position-related data provide by a positioning system and an ability to provide timely and valid warnings to a location service (LCS) client when the positioning system does not fulfil a condition for an intended operation. The concepts of positioning integrity have already been introduced and supported for global navigation satellite system (GNSS) positioning in 3rd generation partnership project (3GPP) Rel-17. However, details regarding integrity support for RAT-dependent positioning have not been studied yet.

### SUMMARY OF THE APPLICATION

Embodiments of the present application at least provide technical solutions for RAT-dependent positioning integrity.

According to some embodiments of the present application, a user equipment (UE) may include: a processor configured to obtain integrity assistance data of the UE; and a transmitter coupled to the processor and configured to transmit the integrity assistance data of the UE to a location management function (LMF); and a receiver coupled to the processor.

In some embodiments of the present application, the integrity assistance data includes at least one of: integrity assistance information which includes at least one of error source(s) or UE-assisted information; or predicted integrity assistance information.

In some embodiments of the present application, the UE-assisted information includes at least one of: a type of the UE; an expected state of the UE to perform positioning; a reference signal receiving power (RSRP) value measured by the UE; an indication indicating a location range of the UE; or a synchronization status of the UE.

In some embodiments of the present application, the transmitter is further configured to transmit the integrity assistance information to a network data analytics function (NWDAF), and the receiver is configured to receive the predicted integrity assistance information based on the integrity assistance information from the NWDAF.

In some embodiments of the present application, the processor is further configured to judge a positioning method determined by the LMF based on the predicted integrity assistance information to obtain a judgement result; and the transmitter is further configured to transmit the judgement result to the LMF.

In some embodiments of the present application, the integrity assistance data of the UE is transmitted in a location request message or in an event report message to the LMF.

In some embodiments of the present application, the transmitter is further configured to: transmit an indication in a location request message or in an event report message to indicate whether the integrity assistance data of the UE will be transmitted; and the integrity assistance data of the UE is transmitted in a long term evolution (LTE) positioning protocol (LPP) message to the LMF in response to the indication indicating that the integrity assistance data of the UE will be transmitted.

In some embodiments of the present application, the transmitter is further configured to transmit an indication in a location request message or in an event report message to indicate whether the UE has the capability to transmit the integrity assistance data and whether the UE has the integrity assistance data needed to be transmitted to the LMF; the receiver is configured to receive an integrity assistance data request from the LMF in response to the indication indicating that the UE has the capability to transmit the integrity assistance data and the UE has the integrity assistance data needed to be transmitted to the LMF; and the integrity assistance data of the UE is transmitted to the LMF in response to the integrity assistance data request.

In some embodiments of the present application, the receiver is configured to receive an integrity assistance data request from the LMF; and the integrity assistance data of the UE is transmitted to the LMF in response to the integrity assistance data request, in the case that the UE has the capability to transmit the integrity assistance data and the UE has the integrity assistance data needed to be transmitted to the LMF.

In some embodiments of the present application, the receiver is configured to receive a request message to request capabilities of the UE from the LMF; and the integrity assistance data of the UE is transmitted in a response message which provides the capabilities of the UE to the LMF in response to the request message.

In some embodiments of the present application, the receiver is configured to receive a request message to request capabilities of the UE from the LMF; the transmitter is further configured to: transmit a response message which provides the capabilities of the UE to the LMF in response to the request message, wherein the response message includes an indication indicating whether the integrity assistance data of the UE will be transmitted; and the integrity assistance data of the UE is transmitted in a LPP message to the LMF in response to the indication indicating that the integrity assistance data of the UE will be transmitted.

In some embodiments of the present application, the receiver is configured to receive a request message to request capabilities of the UE from the LMF, wherein the request message includes an integrity assistance data request. The integrity assistance data of the UE is transmitted in a response message which provides the capabilities of the UE or in a separate LPP message to the LMF in response to the integrity assistance data request, in the case that the UE has the capability to transmit the integrity assistance data and the UE has the integrity assistance data needed to be transmitted to the LMF.

According to some other embodiments of the present application, a radio access network (RAN) node may include: a receiver configured to receive an indication indicating the RAN node to transmit integrity assistance data of the RAN node to an LMF; a transmitter configured to transmit the integrity assistance data of the RAN node to the LMF in response to the indication, in the case that the RAN node has the capability to transmit the integrity assistance data and the RAN node has the integrity assistance data needed to be transmitted to the LMF; and a processor coupled to the transmitter and the receiver.

In some embodiments of the present application, the integrity assistance data includes at least one of: integrity assistance information which includes error source(s); or predicted integrity assistance information.

In some embodiments of the present application, the transmitter is further configured to transmit the integrity assistance information to an NWDAF, and the receiver is further configured to receive the predicted integrity assistance information based on the integrity assistance information from the NWDAF.

In some embodiments of the present application, the processor is further configured to judge a positioning method determined by the LMF based on the predicted integrity assistance information to obtain a judgement result; and the transmitter is further configured to transmit the judgement result to the LMF.

In some embodiments of the present application, the indication is an integrity assistance data indication received from a UE or an integrity assistance data request received from the LMF, and the integrity assistance data of the RAN node is transmitted in a new radio (NR) positioning protocol A (NRPPa) message.

According to some other embodiments of the present application, an LMF may include: a receiver configured to receive at least one of: first integrity assistance data of a UE from the UE; second integrity assistance data of a RAN node from the RAN node; or predicted integrity assistance information from an NWDAF; a processor coupled to the receiver and configured to determine a RAT-dependent positioning method based on at least one of: the first integrity assistance data, the second integrity assistance data, or the predicted integrity assistance information; and a transmitter coupled to the processor.

In some embodiments of the present application, the first integrity assistance data includes at least one of: first integrity assistance information which includes at least one of error source(s) or UE-assisted information; or first predicted integrity assistance information based on the first integrity assistance information.

In some embodiments of the present application, the UE-assisted information includes at least one of: a type of the UE; an expected state of the UE to perform positioning; an RSRP value measured by the UE; an indication indicating a location range of the UE; or a synchronization status of the UE.

In some embodiments of the present application, the second integrity assistance data includes at least one of: second integrity assistance information which includes error source(s); or second predicted integrity assistance information based on the second integrity assistance information.

In some embodiments of the present application, the predicted integrity assistance information is based on at least one of: first integrity assistance information of the UE which includes at least one of error source(s) or UE-assisted information; or second integrity assistance information of the RAN node which includes error source(s).

In some embodiments of the present application, the first integrity assistance data is received in a location request message or in an event report message.

In some embodiments of the present application, the receiver is further configured to: receive an indication in a location request message or in an event report message which indicates whether the first integrity assistance data will be transmitted from the UE; and the first integrity assistance data is received in an LPP message from the UE in response to the indication indicating that the first integrity assistance data will be transmitted.

In some embodiments of the present application, the receiver is further configured to receive, from the UE, an indication in a location request message or in an event report message which indicates whether the UE has the capability to transmit the first integrity assistance data and whether the UE has the first integrity assistance data needed to be transmitted to the LMF; the transmitter is further configured to transmit an integrity assistance data request to the UE in response to the indication indicating that the UE has the capability to transmit the first integrity assistance data and the UE has the first integrity assistance data needed to be transmitted to the LMF; and the first integrity assistance data is received from the UE in response to the integrity assistance data request.

In some embodiments of the present application, the receiver is further configured to receive a location request message; the transmitter is further configured to transmit an integrity assistance data request to the UE after receiving the location request message; and the first integrity assistance data is received from the UE in response to the integrity assistance data request.

In some embodiments of the present application, the transmitter is further configured to transmit, to the UE, a request message to request capabilities of the UE; and the first integrity assistance data is received in a response message from the UE which provides the capabilities of the UE in response to the request message.

In some embodiments of the present application, the transmitter is further configured to transmit, to the UE, a request message to request capabilities of the UE; the receiver is further configured to: receive, from the UE, a response message which provides the capabilities of the UE in response to the request message, wherein the response message includes an indication indicating whether the first integrity assistance data of the UE will be transmitted; and the first integrity assistance data is received in a LPP message from the UE in response to the indication indicating that the first integrity assistance data of the UE will be transmitted.

In some embodiments of the present application, the transmitter is further configured to transmit, to the UE, a request message to request capabilities of the UE, wherein the request message includes an integrity assistance data request. The first integrity assistance data is received in a response message which provides the capabilities of the UE or in a separate LPP message from the UE in response to the integrity assistance data request.

In some embodiments of the present application, the second integrity assistance data of the RAN node is received in a NRPPa message.

In some embodiments of the present application, the transmitter is further configured to transmit an integrity assistance data request to the RAN node; and the second integrity assistance data is received from the RAN node in response to the integrity assistance data request.

According to some other embodiments of the present application, a method performed by a UE may include: obtaining integrity assistance data of the UE; and transmitting the integrity assistance data of the UE to an LMF.

According to some other embodiments of the present application, a method performed by a RAN node may include: receiving an indication indicating the RAN node to transmit integrity assistance data of the RAN node to an LMF; and transmitting the integrity assistance data of the RAN node to the LMF in response to the indication, in the case that the RAN node has a capability to transmit the integrity assistance data and the RAN node has the integrity assistance data needed to be transmitted to the LMF.

According to some other embodiments of the present application, a method performed by an LMF may include: receiving at least one of: first integrity assistance data of a UE from the UE; second integrity assistance data of a RAN node from the RAN node; or predicted integrity assistance information from an NWDAF; and determining a RAT-dependent positioning method based on at least one of: the first integrity assistance data, the second integrity assistance data, or the predicted integrity assistance information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates a flowchart of an exemplary method for determining a RAT-dependent positioning method according to some embodiments of the present application;

FIG. 3 illustrates a flowchart of another exemplary method for determining a RAT-dependent positioning method according to some other embodiments of the present application; and

FIG. 4 illustrates a simplified block diagram of an exemplary apparatus for RAT-dependent positioning integrity according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G (i.e., NR), 3GPP LTE, and so on. Persons skilled in the art know very well that, with the development of network architecture and new service scenarios, the embodiments in the present application are also applicable to similar technical problems; and moreover, the terminologies recited in the present application may change, which should not affect the principle of the present application.

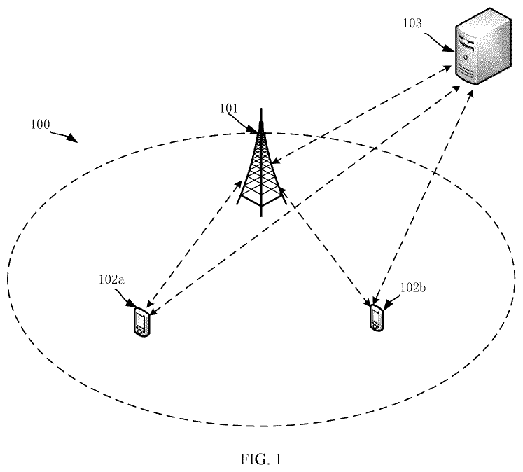

FIG. 1 is a schematic diagram illustrating an exemplary wireless communication system 100 according to some embodiments of the present application.

As shown in FIG. 1, the wireless communication system 100 includes at least one RAN node 101, at least one UE (e.g., a UE 102a and a UE 102b), and at least one LMF 103. Although one RAN node, two UEs, and one LMF are depicted in FIG. 1 for illustrative purpose, it is contemplated that any number of RAN nodes, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The RAN node 101 may be an access point, an access terminal, a transmission-reception point (TRP), a base, a base station (BS), a next generation (NG) RAN node, a node-B, an enhanced node B (eNB), a gNB, a home node-B, a relay node, or a device, or described using other terminology used in the art. The RAN node 101 is generally part of a RAN that may include a controller communicably coupled to the RAN node 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the RAN node 101, and may transmit information or data to the RAN node 101 and receive control information or data from the RAN node 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the RAN node 101 via the NRPPa signaling, and may communicate with the UE 102a or UE 102b via LPP signaling.

When a location service request is initiated or occurs at a UE, the UE (referred to as target UE or LCS target UE) needs to know its own position. When the target UE is within a coverage area of a BS or network (i.e., in coverage), the target UE may get positioning information from the BS or LMF, which is known as Uu positioning or NR Uu positioning. The NR Uu positioning may include RAT-dependent positioning. The RAT-dependent positioning may mean that the UE's position is calculated based on reference signal (e.g., sounding reference signal (SRS), positioning reference signal (PRS), and/or other reference signal) measurement(s) in Uu interface.

Positioning integrity refers to a measure of trust in an accuracy of the position-related data provide by a positioning system and an ability to provide timely and valid warnings to an LCS client when the positioning system does not fulfil a condition for an intended operation. For example, each time a position is provided, positioning integrity can be used to quantify the trust on the provided position. The concepts of positioning integrity have already been introduced and supported for GNSS positioning in 3GPP Rel-17. However, there is no study on integrity for RAT-dependent positioning.

For example, in the current RAT-dependent positioning procedures, when an LMF receives capability information of a UE, it may determine a RAT-dependent positioning method for the UE based on the capability information. The RAT-dependent positioning method may be one of: new radio enhanced cell identity (NR-ECID) positioning method, multi-round trip time (multi-RTT) positioning method, downlink angle of departure (DL-AoD) positioning method, downlink time difference of arrival (DL-TDOA) positioning method, uplink time difference of arrival (UL-TDOA) positioning method, uplink angle of arrival (UL-AoA) positioning method, etc. The capability information may include: the ability of the UE to support different positioning methods defined for LPP, different aspects of a particular positioning method and common features not specific to only one positioning method (e.g. ability to handle multiple LPP transactions). That is, the above capability information does not include information related to the integrity, which may decrease the trust in the position accuracy. To guarantee the feasibility of the positioning architecture and ensure to adopt an optimized RAT-dependent positioning method, integrity assistance data may need to be considered when the LMF determines a RAT-dependent positioning method.

Given the above, embodiments of the present application propose solutions for RAT-dependent positioning integrity. For example, embodiments of the present application propose solutions regarding contents of integrity assistance data for determining a RAT-dependent positioning method, and signaling transfer procedures of integrity assistance data. The solutions in the embodiments of the present application can improve the positioning integrity for a RAT-dependent positioning method by considering the integrity assistance data when determining the RAT-dependent positioning method. More details on embodiments of the present application will be described in the following text in combination with the appended drawings.

Different from GNSS positioning in which a UE is equipped with a GNSS receiver and integrity related information is only transferred between the UE and an LMF, RAT-dependent positioning techniques may utilize one or more positioning methods, which involve three entities, i.e., UE, RAN node (e.g., a BS, a TRP, etc.) and LMF, to perform measurements for different positioning metrics. Each entity may generate error sources which may affect the integrity performance. Given this, the following embodiments of the present application provide integrity assistance data of the UE side and the RAN node side, and signaling procedures for transferring the integrity assistance data from the UE to the LMF and for transferring the integrity assistance data from the RAN node to the LMF.

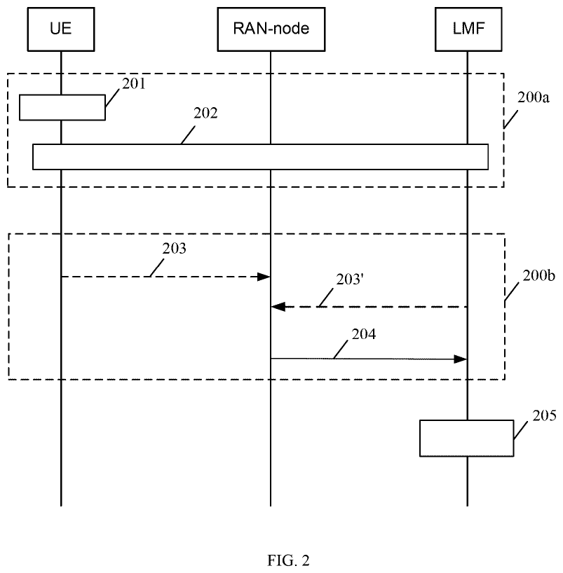

FIG. 2 illustrates a flowchart of an exemplary method for determining a RAT-dependent positioning method according to some embodiments of the present application. The method illustrated in FIG. 2 may be performed by at least three network entities, e.g., a UE, a RAN node (e.g., a BS, a TRP, etc.), and an LMF. Although the method is illustrated in a system level, persons skilled in the art can understand that the method implemented in the three network entities can be separately implemented and incorporated in other apparatus with the like functions.

In the embodiments of FIG. 2, integrity assistance data from the UE and the RAN node may be transmitted to the LMF during location request procedures. The flowchart illustrated in FIG. 2 may include a procedure 200a for transmitting integrity assistance data of the UE to the LMF and a procedure 200b for transmitting integrity assistance data of the RAN node to the LMF. Although FIG. 2 illustrates both the procedure 200a and the procedure 200b, it does not mean that both procedures must occur. It can be contemplated that only one or both of the procedure 200a and the procedure 200b may occur in the embodiments of the present application.

Referring to FIG. 2, the procedure 200a may include steps 201 and 202. In step 201, a UE (e.g., UE 102a or UE 102b in FIG. 1) may obtain integrity assistance data of the UE (also referred to as integrity assistance data of the UE side).

In some embodiments of the present application, the integrity assistance data of the UE may include at least one of: integrity assistance information or predicted integrity assistance information. The integrity assistance information may include at least one of: error source(s) or UE-assisted information. The predicted integrity assistance information may be based on the integrity assistance information, which will be described below.

The error source(s) may include at least one of:
line of sight (LoS) indicator generated by the UE or not line of sight (NLOS) indicator generated by the UE;
the UE's capability;
geometric dilution precision (GDOP) of the UE's location;
the UE's velocity;
the UE's mobility;
error source(s) for timing-based positioning methods, which includes at least one of: the UE's measurements errors (e.g., time of arrival (ToA), receiver (Rx)-transmitter (Tx) timing difference, etc.), error sources resulting from multipath or NLOS channel or radio propagation environment, the UE's timing
error source(s) for angle-based positioning methods, which includes at least one of: the UE's measurements errors (e.g., angle of arrival (AoA), RSRP, etc.), error sources resulting from multipath or NLOS channel or radio propagation environment, etc.; or
other error sources of the UE side which may affect the integrity performance.

The UE-assisted information may include at least one of:
A type of the UE. For example, the type of the UE may indicate at least one of: a low power UE, a low power high accuracy positioning (LPHAP) UE, a narrow band internet of things (NB-IOT) UE, etc.;
An expected state of the UE to perform positioning. For example, the expected state may be a radio resource control (RRC) CONNECTED state, an RRC INACTIVE state, or an RRC IDLE state;
An RSRP value measured by the UE;
An indication indicating a location range of the UE. In some embodiments, the location range of the UE may be a cell center or a cell edge. In some embodiments, the indication may be a bitmap of the UE's location in a serving cell. For example, assuming that the coverage of a serving cell is divided into eight location ranges, the bitmap may include eight bits, wherein each bit may correspond to a location range of the eight location ranges and indicate whether the UE is located in the corresponding location range, for example, the bitmap may be “00001000” which indicates that the UE is located in the fifth location range of the serving cell. In some embodiments, the indication may be the RSRP value of the serving cell measured by the UE or a result obtained by comparing the RSRP value with a threshold; or
A synchronization status of the UE. For example, the synchronization status may be an in-sync indication, an out-of-sync indication, timing advance (TA) configuration(s) of the UE, etc.

In some embodiments of the present application, an artificial intelligence (AI) model may additionally or alternatively be used for generating integrity assistance data of the UE side. In such embodiments, the UE may transmit the aforementioned integrity assistance information to an NWDAF (which is not shown in FIG. 2). After receiving the integrity assistance information of the UE, the NWDAF (e.g., an “Analyzer” inside of the NWDAF) may use its trained AI model to predict the integrity assistance information of the UE, and output the predicted integrity assistance information of the UE. For example, the predicted integrity assistance information may include an error probability of the integrity assistance information with a time label. In another example, the predicted integrity assistance information may include any other information which is obtained based on the integrity assistance information of the UE.

After generating the predicted integrity assistance information of the UE, in an embodiment, the NWDAF may transmit the predicted integrity assistance information of the UE to the LMF assisting the LMF to make a positioning method decision (which will be described below).

In another embodiment, the NWDAF may transmit the predicted integrity assistance information of the UE to the UE. After receiving the predicted integrity assistance information, in some examples, the UE may transmit the predicted integrity assistance information to the LMF. In other words, in such examples, the integrity assistance data transmitted from the UE to the LMF may include the predicted integrity assistance information. In some other examples, the UE may not transmit the predicted integrity assistance information to the LMF. In some embodiments, the UE may use the predicted integrity assistance information to judge a positioning method determined by the LMF. For example, the UE may judge a positioning method determined by the LMF based on the predicted integrity assistance information to obtain a judgement result. In some embodiments, the UE may transmit the judgement result to the LMF.

After obtaining the integrity assistance data in step 201, in step 202, the UE may transmit the integrity assistance data of the UE to the LMF. The following three options may provide different operations in step 202.

### Option 1

In some embodiments of option 1, in step 202, the integrity assistance data may be transmitted in a location request message to the LMF. Such embodiments may support mobile originated location request (MO-LR) location services. For example, for an MO-LR location service, a UE may send a request to a serving public land mobile network (PLMN) for location related information for the UE.

In an embodiment, the location request message may be based on the location request message as specified in TS 23.273, and may be referred to as “an enhanced location request message.” In such embodiment, the enhanced location request message may include the information in the location request message as specified in TS 23.273, and the integrity assistance data of the UE as described above.

In some other embodiments of option 1, in step 202, the integrity assistance data may be transmitted in an event report message to the LMF. Such embodiments may support deferred mobile terminated location request (MT-LR) location services. For example, for a deferred MT-LR location service, an LCS client or application function (AF) may send a location request to a PLMN for a target UE (or group of target UEs) and expect to receive a response containing an indication of event occurrence and location information if requested for the target UE (or group of target UEs) at some future time (or times), which may be associated with specific events associated with the target UE (or group of target UEs).

In an embodiment, the event report message may be based on the event report message as specified in TS 23.273, and may be referred to as “an enhanced event report message.” In such embodiment, the enhanced event report message may include the information in the event report message as specified in TS 23.273, and the integrity assistance data of the UE as described above.

### Option 2

In option 2, step 202 may further include two sub-steps, i.e., sub-step 1 and sub-step 2 (not shown in FIG. 2).

In some embodiments of option 2, in the sub-step 1, the UE may transmit a location request message to the LMF. The location request message may include an indication (or a flag) indicating whether the integrity assistance data of the UE will be transmitted. Such embodiments may support MO-LR location services. For example, the indication may be a 1-bit indication, wherein the value “1” indicates that the integrity assistance data of the UE will be transmitted to the LMF and the value “0” indicates that the integrity assistance data of the UE will not be transmitted to the LMF, or vice versa.

In an embodiment, the location request message may be based on the location request message as specified in TS 23.273, and may be referred to as “an enhanced location request message.” In such embodiment, the enhanced location request message may include the information in the location request message as specified in TS 23.273, and the indication as described above.

In response to the indication indicating that the integrity assistance data of the UE will be transmitted, in the sub-step 2, the UE may transmit an LPP message (e.g., LPP protocol data unit (PDU) message) including the integrity assistance data to the LMF.

In some other embodiments of option 2, in the sub-step 1, the UE may transmit an event report message to the LMF. The event report message may include an indication (or a flag) indicating whether the integrity assistance data of the UE will be transmitted. Such embodiments may support deferred MT-LR location services. For example, the indication may be a 1-bit indication, wherein the value “1” indicates that the integrity assistance data of the UE will be transmitted to the LMF and the value “0” indicates that the integrity assistance data of the UE will not be transmitted to the LMF, or vice versa.

In an embodiment, the event report message may be based on the event report message as specified in TS 23.273, and may be referred to as “an enhanced event report message.” In such embodiment, the enhanced event report message may include the information in the event report message as specified in TS 23.273, and the indication as described above.

In response to the indication indicating that the integrity assistance data of the UE will be transmitted, in the sub-step 2, the UE may transmit an LPP message (e.g., LPP PDU message) including the integrity assistance data to the LMF.

### Option 3

In option 3, the integrity assistance data of the UE may be included in an integrity assistance data response message. Option 3 may support MO-LR, MT-LR and deferred MT-LR location services.

In some embodiments of option 3, for the MO-LR location services, step 202 may further include three sub-steps (not shown in FIG. 2). Specifically, in the first sub-step, the UE may transmit a location request message to the LMF. The location request message may include an indication (or a flag) indicating whether the UE has a capability to transmit the integrity assistance data and whether the UE has the integrity assistance data needed to be transmitted to the LMF. For example, the indication may be a 1-bit indication, wherein the value “1” indicates that the UE has a capability to transmit the integrity assistance data and the UE has the integrity assistance data needed to be transmitted to the LMF and the value “0” indicates that the UE does not have a capability to transmit the integrity assistance data or the UE does not have the integrity assistance data needed to be transmitted to the LMF, or vice versa.

In an embodiment, the location request message may be based on the location request message as specified in TS 23.273, and may be referred to as “an enhanced location request message.” In such embodiment, the enhanced location request message may include the information in the location request message as specified in TS 23.273, and the indication as described above.

After receiving the location request message, in the second sub-step, in response to the indication indicating that the UE has the capability to transmit the integrity assistance data and the UE has the integrity assistance data needed to be transmitted to the LMF, the LMF may transmit an integrity assistance data request to the UE to request the integrity assistance data. In an embodiment, the integrity assistance data request may be included in an LPP message (e.g., LPP PDU message).

In the third sub-step, the UE may transmit the integrity assistance data to the LMF in response to the integrity assistance data request. In an embodiment, the integrity assistance data may be included in an integrity assistance data response. In an embodiment, the integrity assistance data response may be included in a LPP message (e.g., LPP PDU message).

In some other embodiments of option 3, for the deferred MT-LR location services, step 202 may further include three sub-steps (not shown in FIG. 2). Specifically, in the first sub-step, the UE may transmit an event report message to the LMF. The event report message may include an indication (or a flag) indicating whether the UE has a capability to transmit the integrity assistance data and whether the UE has the integrity assistance data needed to be transmitted to the LMF. All the definitions provided above regarding the indication used for the MO-LR location services in option 3 may also apply here.

In an embodiment, the event report message may be based on the event report message as specified in TS 23.273, and may be referred to as “an enhanced event report message.” In such embodiment, the enhanced event report message may include the information in the event report message as specified in TS 23.273, and the indication as described above.

For the deferred MT-LR location services, the second sub-step and the third sub-step of step 202 may be the same as those for the MO-LR location services in option 3.

In some other embodiments of option 3, for the MT-LR location services, step 202 may further include two sub-steps (not shown in FIG. 2). Specifically, after the LMF receives a location request message from a core network (e.g., access and mobility management function (AMF)), in the first sub-step of step 202, the LMF may transmit an integrity assistance data request to the UE. In an embodiment, the integrity assistance data request may be included in an LPP message (e.g., LPP PDU message).

In response to the integrity assistance data request, in the second sub-step of step 202, in the case that the UE has a capability to transmit the integrity assistance data and the UE has the integrity assistance data needed to be transmitted to the LMF, the UE may transmit the integrity assistance data to the LMF. In an embodiment, the integrity assistance data may be included in an integrity assistance data response. In an embodiment, the integrity assistance data response may be included in an LPP message (e.g., LPP PDU message). Otherwise, the UE may transmit an indication indicating “error” to the LMF. For example, the indication may be an LPP message including a field indicating “error.” After that, the UE and the LMF may continue the legacy LPP transmission procedures for positioning.

As stated above, procedure 200b may be used for transferring integrity assistance data of the RAN node to the LMF. Transferring the integrity assistance data of the RAN node to the LMF may be triggered by the UE or by the LMF. Due to the different network nodes for triggering the above transfer, the operations in procedure 200b may be different.

According to some embodiments of the present application, transferring the integrity assistance data of the RAN node to the LMF may be triggered by the UE. Such embodiments may support MO-LR location services. In such embodiments, the procedure 200b may include steps 203 and 204.

In step 203, the UE may transmit an indication indicating the RAN node to transmit integrity assistance data of the RAN node to the LMF. In an embodiment, the indication is an integrity assistance data indication. Step 203 may occur before, after or simultaneously with step 202.

In the case that the RAN node has a capability to transmit the integrity assistance data and the RAN node has the integrity assistance data needed to be transmitted to the LMF, in step 204, the RAN node may transmit the integrity assistance data of the RAN node to the LMF in response to the indication received in step 203. In an embodiment, the integrity assistance data of the RAN node may be transmitted in a NRPPa message.

The integrity assistance data of the RAN node (also referred to as integrity assistance data of the RAN node side) may include at least one of: integrity assistance information of the RAN node or predicted integrity assistance information of the RAN node. The integrity assistance information of the RAN node may include error source(s) of the RAN node. The predicted integrity assistance information of the RAN node may be based on the integrity assistance information of RAN node, which will be described below.

The error source(s) may include at least one of:
the RAN node's coordinates;
the RAN node's antenna information, e.g., antenna height, antenna calibration, etc.;
the RAN node's beam information, e.g., beamwidth, beam pattern, etc.;
GDOP of the RAN node's location;
error source(s) for timing-based positioning methods, which includes at least one of: the RAN node's measurements errors (e.g., ToA, Rx-Tx timing difference, etc.), error sources resulting from multipath or NLOS channel or radio propagation environment, the RAN node's timing error, etc.;
error source(s) for angle-based positioning methods, which includes at least one of: the RAN node's measurements errors (e.g., AoA, RSRP, RSRPP, etc.), error sources resulting from multipath or NLOS channel or radio propagation environment, etc.; or
other error sources of the RAN node side which may affect the integrity performance.

In some embodiments of the present application, an AI model may additionally or alternatively be used for generating integrity assistance data of the RAN node. In such embodiments, the RAN node may transmit the aforementioned integrity assistance information to an NWDAF (which is not shown in FIG. 2). After receiving the integrity assistance information of the RAN node, the NWDAF (e.g., an “Analyzer” inside of the NWDAF) may use its trained AI model to predict the integrity assistance information of the RAN node, and output the predicted integrity assistance information of the RAN node. For example, the predicted integrity assistance information may include an error probability of the integrity assistance information with a time label. In another example, the predicted integrity assistance information may include any other information which is obtained based on the integrity assistance information of the RAN node.

After generating the predicted integrity assistance information of the RAN node, in an embodiment, the NWDAF may transmit the predicted integrity assistance information of the RAN node to the LMF assisting the LMF to make a positioning method decision (which will be described below).

In another embodiment, the NWDAF may transmit the predicted integrity assistance information of the RAN node to the RAN node. After receiving the predicted integrity assistance information, in some examples, the RAN node may transmit the predicted integrity assistance information to the LMF. In other words, in such embodiments, the integrity assistance data transmitted from the RAN node to the LMF may include the predicted integrity assistance information of the RAN node. In some other examples, the RAN node may not transmit the predicted integrity assistance information to the LMF. In some embodiments, the RAN node may use the predicted integrity assistance information to judge a positioning method determined by the LMF. For example, the RAN node may judge a positioning method determined by the LMF based on the predicted integrity assistance information to obtain a judgement result. In some embodiments, the RAN node may transmit the judgement result to the LMF.

According to some other embodiments of the present application, transferring the integrity assistance data of the RAN node to the LMF may be triggered by the LMF. Such embodiments may support MO-LR, MT-LR and deferred MT-LR location services. In such embodiments, the procedure 200b may include steps 203′ and 204.

In step 203′, the LMF may transmit an indication indicating the RAN node to transmit integrity assistance data of the RAN node to the LMF. The indication may be an integrity assistance data request. In an embodiment, the integrity assistance data request may be transmitted in a NRPPa message to the RAN node. Step 203′ may occur before, after or simultaneously with step 202.

In the case that the RAN node has a capability to transmit the integrity assistance data and the RAN node has the integrity assistance data needed to be transmitted to the LMF, in step 204, the RAN node may transmit the integrity assistance data of the RAN node to the LMF in response to the integrity assistance data request. Otherwise, the RAN node may transmit an indication indicating “error” to the LMF. For example, the indication may be a NRPPa message including a field indicating “error.” After that, the RAN node and the LMF may continue the legacy LPP transmission procedures for positioning.

In an embodiment, the integrity assistance data of the RAN node may be transmitted in an integrity assistance data response. In an embodiment, the integrity assistance data response may be transmitted in a NRPPa message to the LMF. All the operations and definitions regarding the integrity assistance data of the RAN node described in the above embodiments for MO-LR location services may also apply here.

Consequently, the LMF may receive at least one of: the integrity assistance data of the UE from the UE; the integrity assistance data of the RAN node from the RAN node; or predicted integrity assistance information from the NWDAF.

The predicted integrity assistance information from the NWDAF may include at least one of: the predicted integrity assistance information of the UE (which is generated based on the integrity assistance information of the UE); or the predicted integrity assistance information of the RAN node (which is generated based on the integrity assistance information of the RAN node).

In step 205, the LMF may determine a RAT-dependent positioning method based on at least one of: the integrity assistance data of the UE, the integrity assistance data of the RAN node, or the predicted integrity assistance information from the NWDAF. For example, the RAT-dependent positioning method may be one determined or selected from: an NR-ECID positioning method, a multi-RTT positioning method, a DL-AoD positioning method, a DL-TDOA positioning method, a UL-TDOA positioning method, a UL-AoA positioning method, etc.

According to some embodiments of the present application, after determining the RAT-dependent positioning method, the UE, the RAN-node, and the LMF may further perform at least one of the following procedures or operations for fulfilling the positioning operation.
LPP procedures: The LMF (or the UE) may instigate one or more LPP procedures to achieve at least one of: transferring the UE's positioning capabilities, providing assistance data to the UE, or obtaining location information from the UE (or the LMF). In some embodiments, the LPP procedures to transfer the UE's positioning capabilities and the RAN node's coordinates may be skipped since the LMF already obtained such information in the integrity assistance data received in procedures 200a and 200b as described above.
NRPPa procedures: In some cases, if the LMF needs location related information for the UE from the RAN node, the LMF may instigate one or more NRPPa procedures.
Location response operation: The LMF may transmit a location response message to the UE or to the network.

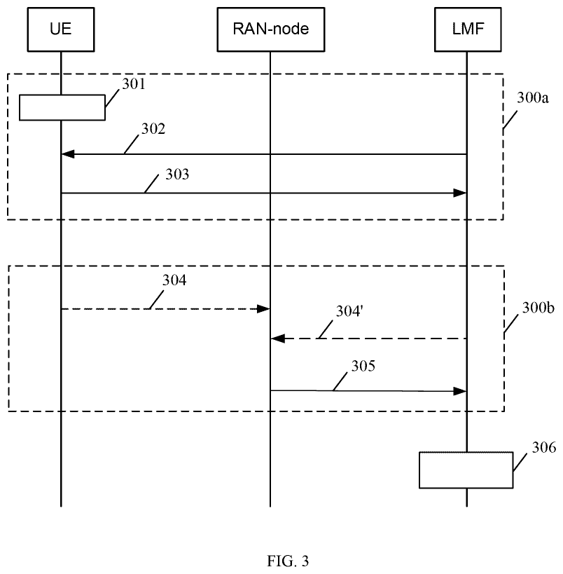

FIG. 3 illustrates a flowchart of another exemplary method for determining a RAT-dependent positioning method according to some other embodiments of the present application. The method illustrated in FIG. 3 may be performed by at least three network entities, e.g., a UE, a RAN node (e.g., a BS, a TRP, etc.), and an LMF. Although the method is illustrated in a system level, persons skilled in the art can understand that the method implemented in the three network entities can be separately implemented and incorporated in other apparatus with the like functions.

In the embodiments of FIG. 3, the integrity assistance data from the UE and the RAN node may be transmitted to the LMF during LPP capability procedures. The flowchart illustrated in FIG. 3 may include a procedure 300a for transmitting the integrity assistance data of the UE to the LMF and a procedure 300b for transmitting the integrity assistance data of the RAN node to the LMF. Although FIG. 3 illustrates both the procedure 300a and the procedure 300b, it does not mean that both procedures must occur. It can be contemplated that only one or both of the procedure 300a and the procedure 300b may occur in the embodiments of the present application.

Referring to FIG. 3, the procedure 300a may include steps 301, 302, and 303. In step 301, a UE (e.g., UE 102a or UE 102b in FIG. 1) may obtain integrity assistance data of the UE (also referred to as integrity assistance data of the UE side). All the definitions and operations regarding the integrity assistance data of the UE described with respect to step 201 in FIG. 2 may also apply here.

In some embodiments of the present application, the LMF may receive a location request message from the UE (e.g., for the MO-LR location services), or the LMF may receive a location request message from the AMF (e.g., for the MT-LR location services), or receive an event report message from the UE (e.g., for the deferred MT-LR location services). In response to receiving the location request message from the UE, the location request message from the AMF, or the event report message from the UE, the LMF may trigger a capability information transfer procedure which includes steps 302 and 303. In the capability information transfer procedure, the integrity assistance data of the UE may be transferred from the UE to the LMF. The following three options may provide different operations in steps 302 and 303.

### Option 1′

In option 1′, in step 302, the LMF may transmit, to the UE, a request message (e.g., the LPP RequestCapabilities message as specified in 3GPP standard documents) to request capabilities of the UE.

In step 303, in response to the request message, the UE may transmit the integrity assistance data of the UE in a response message which provides the capabilities of the UE to the LMF. For example, the response message may be based on an LPP ProvideCapacities message as specified in 3GPP standard documents, and may be referred to as “an enhanced LPP ProvideCapacities message.” In such embodiment, the response message may include the information in the LPP ProvideCapacities message as specified in TS 36.305 and TS 38.305, and the integrity assistance data of the UE.

### Option 2′

In option 2′, in step 302, the LMF may transmit, to the UE, a request message (e.g., the LPP RequestCapabilitiessage as specified in 3GPP standard documents) to request capabilities of the UE.

Step 303 may further include two sub-steps (not shown in FIG. 3).

In the first sub-step of step 303, in response to the request message, the UE may transmit a response message which provides the capabilities of the UE to the LMF. The response message may further include an indication (or a flag) indicating whether the integrity assistance data of the UE will be transmitted. For example, the indication may be a 1-bit indication, wherein the value “1” indicates that the integrity assistance data of the UE will be transmitted to the LMF and the value “0” indicates that the integrity assistance data of the UE will not be transmitted to the LMF, or vice versa.

In an embodiment, the response message may be based on an LPP ProvideCapacities message as specified in 3GPP standard documents, and may be referred to as “an enhanced LPP ProvideCapacities message.” In such embodiment, the response message may include the information in the LPP ProvideCapacities message as specified in TS 36.305 and TS 38.305, and the integrity assistance data of the UE.

In response to the indication indicating that the integrity assistance data of the UE will be transmitted, in the second sub-step of step 303, the UE may transmit an LPP message (e.g., LPP PDU message) including the integrity assistance data to the LMF.

### Option 3′

In option 3′, in step 302, the LMF may transmit, to the UE, a request message to request capabilities of the UE. The request message further includes an integrity assistance data request.

In an embodiment, the request message may be based on an LPP RequestCapabilities message as specified in 3GPP standard documents, and may be referred to as “an enhanced LPP RequestCapabilities message.” In such embodiment, the request message may include the information in the LPP RequestCapabilities message as specified in TS 36.305 and TS 38.305, and the integrity assistance data request.

In the case that the UE has a capability to transmit the integrity assistance data and the UE has the integrity assistance data needed to be transmitted to the LMF, in step 303, the UE may transmit the integrity assistance data of the UE to the LMF in response to the integrity assistance data request. Otherwise, the UE may transmit an indication indicating “error” to the LMF. For example, the indication may be a LPP message including a field indicating “error.” After that, the UE and the LMF may continue the legacy LPP transmission procedures for positioning.

In an embodiment, the integrity assistance data of the UE may be transmitted in a response message which provides the capabilities of the UE to the LMF. For example, the response message may be based on an LPP ProvideCapacities message as specified in 3GPP standard documents, and may be referred to as “an enhanced LPP ProvideCapacities message.” In such embodiment, the response message may include the information in the LPP ProvideCapacities message as specified in TS 36.305 and TS 38.305, and the integrity assistance data of the UE.

In another embodiment, the integrity assistance data of the UE may be transmitted in a separate LPP message which is different from the response message which provides the capabilities of the UE to the LMF.

As stated above, procedure 300b may be used for transferring integrity assistance data of the RAN node to the LMF. All the operations and definitions for the integrity assistance data of the RAN node described with respect to FIG. 2 may also apply here.

In FIG. 3, transferring the integrity assistance data of the RAN node to the LMF may be triggered by the UE or by the LMF. Due to the different network node for triggering the above transfer, the operations in procedure 300b may be different.

According to some embodiments of the present application, transferring the integrity assistance data of the RAN node to the LMF may be triggered by the UE. In such embodiments, the procedure 300b may include steps 304 and 305, which are respectively similar to steps 203 and 204 in FIG. 2. The difference between steps 304-305 and steps 203-204 may only lie in their occurrence times. For example, steps 203-204 in FIG. 2 may occur in the location request procedures while steps 304-305 may occur in the capability information transfer procedures. The operations performed in step 304 and the operations performed in step 203 may be the same, and the operations performed in step 305 and the operations performed in step 204 may be the same.

According to some other embodiments of the present application, transferring the integrity assistance data of the RAN node to the LMF may be triggered by the LMF. In such embodiments, the procedure 300b may include steps 304′ and 305, which are respectively similar to steps 203′ and 204 in FIG. 2. The difference between steps 304′-305 and steps 203′-204 may only lie in their occurrence times. For example, steps 203′-204 in FIG. 2 may occur in the location request procedures while steps 304′-305 may occur in the capability information transfer procedures. The operations performed in step 304′ and the operations performed in step 203 may be the same, and the operations performed in step 304 and the operations performed in step 204 may be the same.

Consequently, the LMF may receive at least one of: the integrity assistance data of the UE from the UE; the integrity assistance data of the RAN node from the RAN node; or predicted integrity assistance information from the NWDAF.

The predicted integrity assistance information from the NWDAF may include at least one of: the predicted integrity assistance information of the UE (which is generated based on the integrity assistance information of the UE); or the predicted integrity assistance information of the RAN node (which is generated based on the integrity assistance information of the RAN node).

In step 306, the LMF may determine a RAT-dependent positioning method based on at least one of: the integrity assistance data of the UE, the integrity assistance data of the RAN node, or the predicted integrity assistance information from the NWDAF. For example, the RAT-dependent positioning method may be one determined or selected from: an NR-ECID positioning method, a multi-RTT positioning method, a DL-AoD positioning method, a DL-TDOA positioning method, a UL-TDOA positioning method, a UL-AoA positioning method, etc.

According to some embodiments of the present application, after determining the RAT-dependent positioning method, the UE, the RAN-node, and the LMF may further perform at least one of the following procedures or operations for fulfilling the positioning operation.
Assistance data and location information transfer procedures: The LMF (or the UE) may instigate one or more LPP procedures to achieve at least one of: providing assistance data to the UE or obtaining location information from the UE (or the LMF).
NRPPa procedures: In some cases, if the LMF needs location related information for the UE from the RAN node, the LMF may instigate one or more NRPPa procedures.
Location response operation: The LMF may transmit a location response message to the UE or to the network.

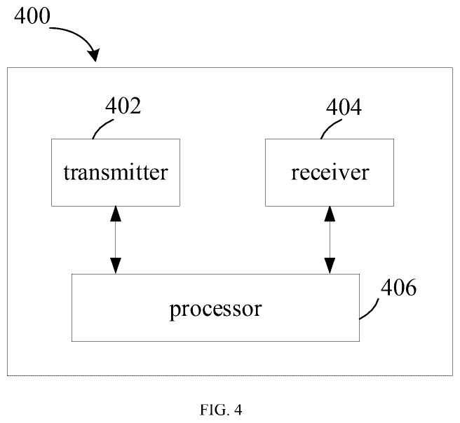

FIG. 4 illustrates a simplified block diagram of an exemplary apparatus 400 for RAT-dependent positioning integrity according to some embodiments of the present application. In some embodiments, the apparatus 400 may be or include at least part of a UE. In some other embodiments, the apparatus 400 may be or include at least part of a RAN node (e.g., a BS, a TRP, etc.). In some other embodiments, the apparatus 400 may be or include at least part of an LMF

Referring to FIG. 4, the apparatus 400 may include at least one transmitter 402, at least one receiver 404, and at least one processor 406. The at least one transmitter 402 is coupled to the at least one processor 406, and the at least one receiver 404 is coupled to the at least one processor 406.

Although in this figure, elements such as the transmitter 402, the receiver 404, and the processor 406 are illustrated in the singular, the plural is contemplated unless a limitation to the singular is explicitly stated. In some embodiments of the present application, the transmitter 402 and the receiver 404 may be combined to one device, such as a transceiver. In some embodiments of the present application, the apparatus 400 may further include an input device, a memory, and/or other components. The transmitter 402, the receiver 404, and the processor 406 may be configured to perform any of the methods described herein (e.g., the methods described with respect to FIGS. 2 and 3 or other methods described in the embodiments of the present application).

According to some embodiments of the present application, the apparatus 400 may be a UE, and the transmitter 402, the receiver 404, and the processor 406 may be configured to perform operations of the UE in any of the methods as described with respect to FIGS. 2 and 3 or other methods described in the embodiments of the present application. For example, the processor 406 is configured to obtain integrity assistance data of the UE. The transmitter 402 is configured to transmit the integrity assistance data of the UE to an LMF.

According to some embodiments of the present application, the apparatus 400 may be a RAN node (e.g., a BS, a TRP, etc.), and the transmitter 402, the receiver 404, and the processor 406 may be configured to perform operations of the RAN node in any of the methods as described with respect to FIGS. 2 and 3 or other methods described in the embodiments of the present application. For example, the receiver 404 is configured to receive an indication indicating the RAN node to transmit integrity assistance data of the RAN node to an LMF. The transmitter 402 is configured to transmit the integrity assistance data of the RAN node to the LMF in response to the indication, in the case that the RAN node has the capability to transmit the integrity assistance data and the RAN node has the integrity assistance data needed to be transmitted to the LMF.

According to some embodiments of the present application, the apparatus 400 may be an LMF, and the transmitter 402, the receiver 404, and the processor 406 may be configured to perform operations of the LMF in any of the methods as described with respect to FIGS. 2 and 3 or other methods described in the embodiments of the present application. For example, the receiver 404 is configured to receive at least one of: first integrity assistance data of a UE from the UE; second integrity assistance data of a RAN node from the RAN node; or predicted integrity assistance information from an NWDAF. The processor 406 is configured to determine a RAT-dependent positioning method based on at least one of: the first integrity assistance data, the second integrity assistance data, or the predicted integrity assistance information.

In some embodiments of the present application, the apparatus 400 may further include at least one non-transitory computer-readable medium. In some embodiments of the present disclosure, the non-transitory computer-readable medium may have stored thereon computer-executable instructions to cause the processor 406 to implement any of the methods as described above. For example, the computer-executable instructions, when executed, may cause the processor 406 to interact with the transmitter 402 and/or the receiver 404, so as to perform operations of the methods, e.g., as described with respect to FIGS. 2 and 3 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for RAT-dependent positioning integrity, including a processor and a memory. Computer programmable instructions for implementing a method for RAT-dependent positioning integrity are stored in the memory, and the processor is configured to perform the computer programmable instructions to implement the method for RAT-dependent positioning integrity. The method for RAT-dependent positioning integrity may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for RAT-dependent positioning integrity according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
obtain integrity assistance data of the UE; and
transmit the integrity assistance data of the UE to a location management function (LMF).

2. The UE of claim 1, wherein the integrity assistance data includes at least one of:
integrity assistance information that includes at least one of error sources or UE-assisted information; or
predicted integrity assistance information.

3. The UE of claim 2, wherein the UE-assisted information includes at least one of:
a type of the UE;
an expected state of the UE to perform positioning;
a reference signal receiving power (RSRP) value measured by the UE;
an indication indicating a location range of the UE; or
a synchronization status of the UE.

4. The UE of claim 2, wherein the at least one processor is further configured to cause the UE to: transmit the integrity assistance information to a network data analytics function (NWDAF), and receive the predicted integrity assistance information based on the integrity assistance information from the NWDAF.

5. The UE of claim 4, wherein the at least one processor is further configured to cause the UE to:
judge a positioning method determined by the LMF based on the predicted integrity assistance information to obtain a judgement result; and
transmit the judgement result to the LMF.

6. The UE of claim 1, wherein the integrity assistance data of the UE is transmitted in a location request message or in an event report message to the LMF.

7. The UE of claim 1, wherein the at least one processor is further configured to cause the UE to:
transmit an indication in a location request message or in an event report message to indicate whether the integrity assistance data of the UE will be transmitted; and
wherein the integrity assistance data of the UE is transmitted in a long term evolution (LTE) positioning protocol (LPP) message to the LMF in response to the indication indicating that the integrity assistance data of the UE will be transmitted.

8. The UE of claim 1, wherein the at least one processor is further configured to cause the UE to:
transmit an indication in a location request message or in an event report message to indicate whether the UE has a capability to transmit the integrity assistance data and whether the UE has the integrity assistance data needed to be transmitted to the LMF;
receive an integrity assistance data request from the LMF in response to the indication indicating that the UE has the capability to transmit the integrity assistance data and the UE has the integrity assistance data needed to be transmitted to the LMF; and
transmit the integrity assistance data of the UE to the LMF in response to the integrity assistance data request.

9. The UE of claim 1, wherein the at least one processor is further configured to cause the UE to:
receive an integrity assistance data request from the LMF; and
transmit the integrity assistance data of the UE to the LMF in response to the integrity assistance data request when the UE has a capability to transmit the integrity assistance data and the UE has the integrity assistance data to be transmitted to the LMF.

10. The UE of claim 1, wherein the at least one processor is further configured to cause the UE to:
receive a request message to request capabilities of the UE from the LMF; and
transmit the integrity assistance data of the UE in a response message that provides the capabilities of the UE to the LMF in response to the request message.

11. The UE of claim 1, wherein the at least one processor is further configured to cause the UE to:
receive a request message to request capabilities of the UE from the LMF;
transmit a response message that provides the capabilities of the UE to the LMF in response to the request message, wherein the response message includes an indication indicating whether the integrity assistance data of the UE will be transmitted; and
transmit the integrity assistance data of the UE in an LPP message to the LMF in response to the indication indicating that the integrity assistance data of the UE will be transmitted.

12. The UE of claim 1, wherein the at least one processor is further configured to cause the UE to:
receive a request message to request capabilities of the UE from the LMF, wherein the request message includes an integrity assistance data request; and
transmit the integrity assistance data of the UE in a response message that provides the capabilities of the UE or in a separate LPP message to the LMF in response to the integrity assistance data request, when the UE has a capability to transmit the integrity assistance data and the UE has the integrity assistance data to be transmitted to the LMF.

13. A radio access network (RAN) node for wireless communication, comprising:
at least one memory; and
at least one processor coupled with the at least one memory and configured to cause the RAN node to:
receive an indication indicating the RAN node to transmit integrity assistance data of the RAN node to a location management function (LMF); and
transmit the integrity assistance data of the RAN node to the LMF in response to the indication when the RAN node has a capability to transmit the integrity assistance data and the RAN node has the integrity assistance data to be transmitted to the LMF.

14. The RAN node of claim 13, wherein the indication is an integrity assistance data indication received from a user equipment (UE) or an integrity assistance data request received from the LMF, and the integrity assistance data of the RAN node is transmitted in a new radio (NR) positioning protocol A (NRPPa) message.

15. A location management function (LMF) for wireless communication, comprising:
at least one memory; and
at least one processor coupled with the at least one memory and configured to cause the LMF to:
receive at least one of:
first integrity assistance data of a user equipment (UE) from the UE;
second integrity assistance data of a radio access network (RAN) node from the RAN node; or
predicted integrity assistance information from a network data analytics function (NWDAF); and
determine a radio access technology (RAT) dependent positioning method based on at least one of: the first integrity assistance data, the second integrity assistance data, or the predicted integrity assistance information.

16. A method performed by a user equipment (UE), the method comprising:
obtaining integrity assistance data of the UE; and
transmitting the integrity assistance data of the UE to a location management function (LMF).

17. The method of claim 16, wherein the integrity assistance data includes at least one of:
integrity assistance information that includes at least one of error sources or UE-assisted information; or
predicted integrity assistance information.

18. The method of claim 17, wherein the UE-assisted information includes at least one of:
a type of the UE;
an expected state of the UE to perform positioning;
a reference signal receiving power (RSRP) value measured by the UE;
an indication indicating a location range of the UE; or
a synchronization status of the UE.

19. The method of claim 17, further comprising transmitting the integrity assistance information to a network data analytics function (NWDAF), and receiving the predicted integrity assistance information based on the integrity assistance information from the NWDAF.

20. The method of claim 19, further comprising:
judging a positioning method determined by the LMF based on the predicted integrity assistance information to obtain a judgement result; and
transmitting the judgement result to the LMF.
